(19) United States
(12) Patent Application Publication
(10) Pub. No.: US 2009/0230090 A1
(43) Pub. Date: Sep. 17, 2009

(54) VACUUM SWITCH

(76) Inventor: Glenn J. Luzzi, Mt. Bethel, PA (US)

Correspondence Address: STROOCK & STROOCK & LAVAN LLP, 180 MAIDEN LANE, NEW YORK, NY, 10038, US

(21) Appl. No.: 12/403,262

(22) Filed: Mar. 12, 2009

Related U.S. Application Data
(60) Provisional application No. 61/036,793, filed on Mar. 14, 2008.

(51) Int. Cl. H01H 33/66

(52) U.S. Cl. 218/140

(57) ABSTRACT

The present invention relates to a switch for initiating or interrupting current flow between two or more terminals. Preferably, the switch provides for two breaks in the circuit when the switch is in the open position, more specifically, by providing a gap between fixed and movable contacts within one or more vacuum bottles. The switch can also include a ground vacuum bottle for connecting one or more of the terminals to ground. Preferably, a visual indicator for the state of the switch is also provided.

### CROSS REFERENCE TO RELATED APPLICATIONS

This application claims the benefit of U.S. Provisional Patent Application Ser. No. 61/036,793, filed Mar. 14, 2008, the entire contents of which is incorporated herein by reference.

### TECHNICAL FIELD OF THE INVENTION

The present invention relates to a vacuum switch assembly that may be used for initiating or interrupting current flow. More particularly, the present invention is directed to a high voltage vacuum switch comprising two or more vacuum interrupters connected in series and furthermore having a ground position.

### BACKGROUND OF THE INVENTION

Switch assemblies and circuit breakers for initiating or interrupting current flow, such as solid dielectric insulated vacuum loadbreak switches, are known in the art. Such switches are typically designed with an operating handle that is permanently affixed to an actuator, which is then permanently affixed to a movable contact of a vacuum loadbreak bottle. The movable contact engages a fixed contact within the vacuum bottle, thereby creating or breaking an electrical circuit for conducting electricity. This prior art configuration, however, can produce undesirable risk to the lineman working on the switch because it is not possible to determine if the vacuum loadbreak bottle contacts are actually separated when the operating handle indicates that the switch is open. The lineman may mistakenly believe that the switch is open and come into contact with a live circuit.

Some prior art switches attempt to resolve this and other issues. For example, many switches use air or SF₆ as the dielectric and switching medium and provide a viewing window, allowing the lineman to see when the switch is in the OPEN or CLOSED positions. These switches have drawbacks, however. The air dielectric switches are substantially large in size and the SF₆ insulated switch can fail if the SF₆ leaks out, which can create environmental problems as well.

A vacuum loadbreak switch also carries the risk of leakage, which creates another hazardous condition. If there is a leak in the vacuum loadbreak bottle, the dielectric strength would be lost between the contacts in the loadbreak bottle and a full circuit voltage can develop on the open circuit side of the bottle. Another inherent drawback is that the contacts within the bottle can weld together during a fault-close operation. If the contacts are welded together sufficiently, the contacts may remain in contact with each other even when the switch is moved to the OPEN position, thus maintaining the full circuit voltage. The lineman would be unaware of the circuit voltage and instead would expect the load side to be de-energized when opening the switch.

In light of the prior art discussed herein, it is desirable to provide a vacuum switch that provides the lineman with a backup contingency to the single vacuum load break bottle. It is also desirable to provide a vacuum switch that is not substantially large in size and which reduces the risk of voltage appearing on the LOAD side when the switch is in the OPEN position.

### SUMMARY OF THE INVENTION

The present invention relates to a novel vacuum switch assembly. An embodiment of the vacuum switch described herein comprises two vacuum bottles connected in series, constructed and arranged such that if one vacuum bottle fails such as by leaking or if the contacts become permanently welded together, the other vacuum bottle can act as a redundant back-up. Preferably, a visual indicator is provided to alert the user, such as the lineman, of the status of the mechanism operating each vacuum bottle (e.g.; mechanism OPEN or mechanism CLOSED). The visual indicator can take many forms, such as a lever, a button, a sign, etc. The vacuum switch preferably has a first position wherein the two vacuum bottles are closed, and a second position wherein the two vacuum bottles are open.

Preferably, the invention further comprises a GROUND position wherein one of the current carrying elements, such as the load-side, is grounded, thereby providing further safety. A third vacuum bottle can be provided, preferably also in series with the load-side vacuum bottle, wherein the third bottle can preferably be for grounding the vacuum switch. Preferably, the vacuum switch includes a GROUND position wherein the line-side vacuum bottle is in the open position.

Each vacuum bottle can include, by way of non-limiting example, a fixed contact and a movable contact therein for opening and closing the vacuum bottle. Accordingly, when a vacuum bottle is in the open position, the two contacts are physically separated without a current flow therebetween thus insulating the terminals connected to the switch. A vacuum bottle in a closed position can include two contacts that are electrically connected, more preferably in physical contact with each other, thus electrically connecting the terminals.

Thus, it is an object of the present invention to provide a method and apparatus for initiating or interrupting current flow that substantially reduces and/or eliminates the risk of current flowing in the apparatus when current interruption is indicated.

Also, it is an object of the present invention to provide a method and apparatus for initiating or interrupting current flow that provides for a terminal to be grounded.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a perspective view of a switch according to an embodiment of the present invention;

FIG. 2 is an alternate perspective view of the switch of FIG. 1;

FIG. 3 is a schematic view of the switch of FIG. 1 in the CLOSED position;

FIG. 4 is a schematic view of the switch of FIG. 1 in a first OPEN position;

FIG. 5 is a schematic view of the switch of FIG. 1 in a second OPEN position;

FIG. 6 is a schematic view of the switch of FIG. 1 in the GROUND position; and

FIG. 7 is a front view of a switch according to an embodiment of the present invention in the GROUND position.

### DETAILED DESCRIPTION OF A PREFERRED EMBODIMENT

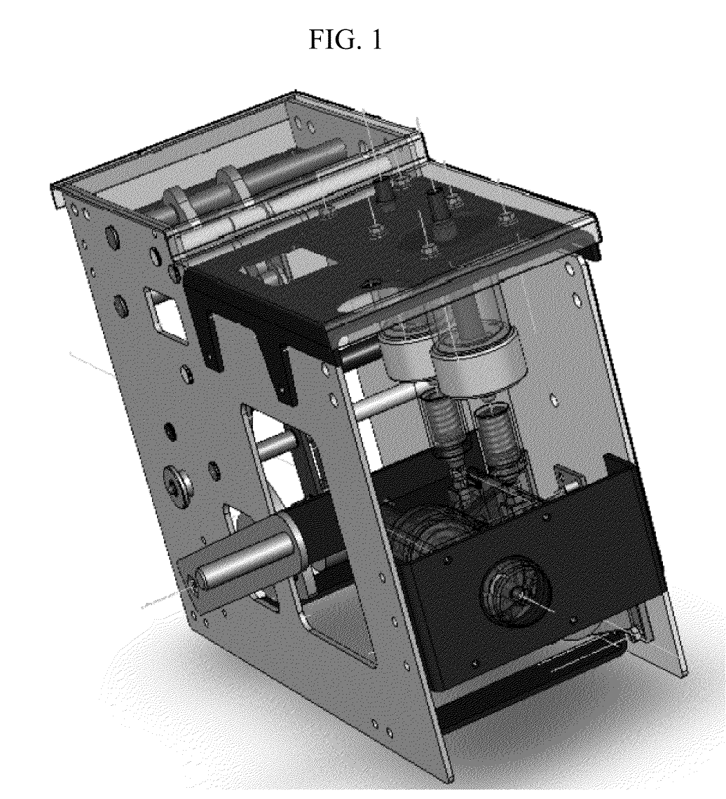

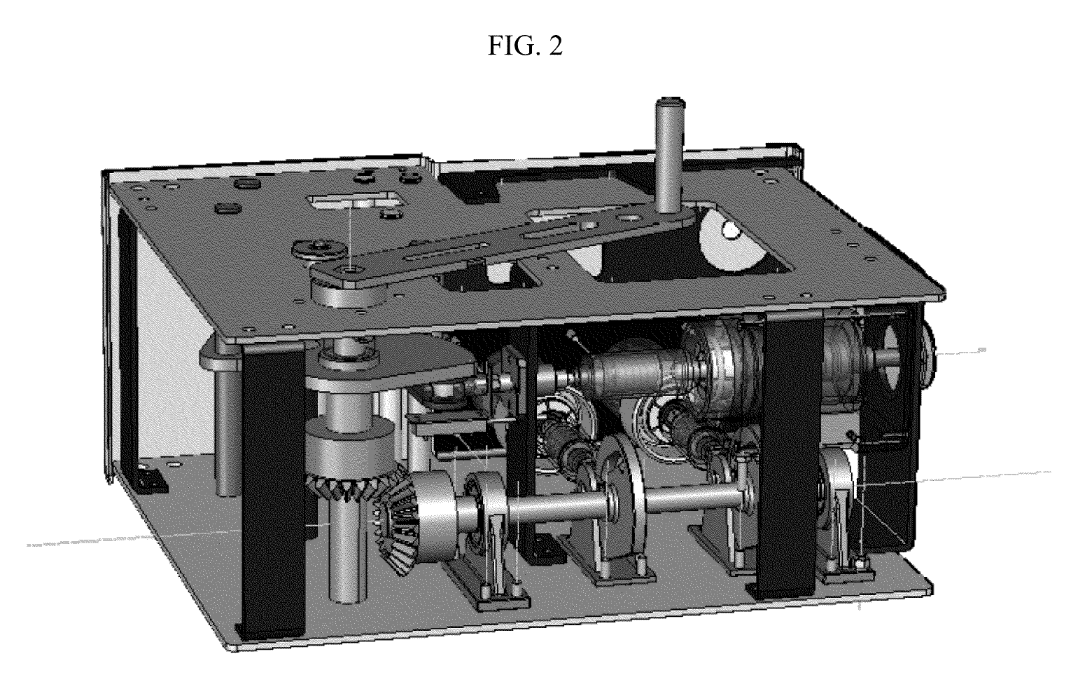

Referring generally to FIGS. 1-6, a switch 1 in accordance with an embodiment of the present invention is shown. In general terms, switch 1 comprises a housing 600 having a line bushing, generally indicated as 10, and a load bushing, generally indicated as 20, that are substantially consistent with bushings known in the art. In accordance with an embodiment of the invention, switch 1 includes a first vacuum bottle 100 and a second vacuum bottle 200 electrically connected in series within housing 600. An embodiment of the switch 1 preferably also includes a ground pad, generally indicated as 30 and a third vacuum bottle referred to herein as ground bottle 300 electrically connected in series with second vacuum bottle 200 but in an OPEN position when switch 1 is in the CLOSED or OPEN positions.

In general terms, a lever 501 is connected to an actuating assembly 400 which can be used to electrically connect and disconnect line bushing 10 and load bushing 20, or to ground switch 1. Preferably, first vacuum bottle 100, second vacuum bottle 200, and ground bottle 300 each include a movable contact (122, 222, 322, respectively), which is selectively displaceable toward and away from a fixed contact (121, 221, 321, respectively). Preferably, movable contact 122, 222, 322 can be displaced away from fixed contact 121, 221, 321 until movable contact 122, 222, 322 is electrically disconnected from fixed contact 121, 221, 321, wherein the vacuum bottle 100, 200, 300 is in the OPEN position. Preferably, a gap 123, 223, 323 exists between movable contact 122, 222, 322 and fixed contact 121, 221, 321 when in the OPEN position. In accordance with an embodiment of switch 1, gap 123, 223, 323 is between approximately 0.10 and 0.70 in, more preferably between approximately 0.25 and 0.50 in, and most preferably approximately 0.25 in.

In the embodiment shown, fixed contacts 121, 221, 321 are connected to line bushing 10, load bushing 20, and ground pad 30, respectively, and movable contacts 122, 222, 322 are connected to actuating assembly 400. Furthermore, movable contact 122, 222, 322 can be displaced toward fixed contact 121, 221, 321 until movable contact 122, 222, 322 is electrically connected to fixed contact 121, 221, 321. Preferably, air gap 123, 223, 323 is reduced until movable contact 122, 222, 322 is physically in contact with fixed contact 121, 221, 321, thus eliminating gap 123, 223, 323.

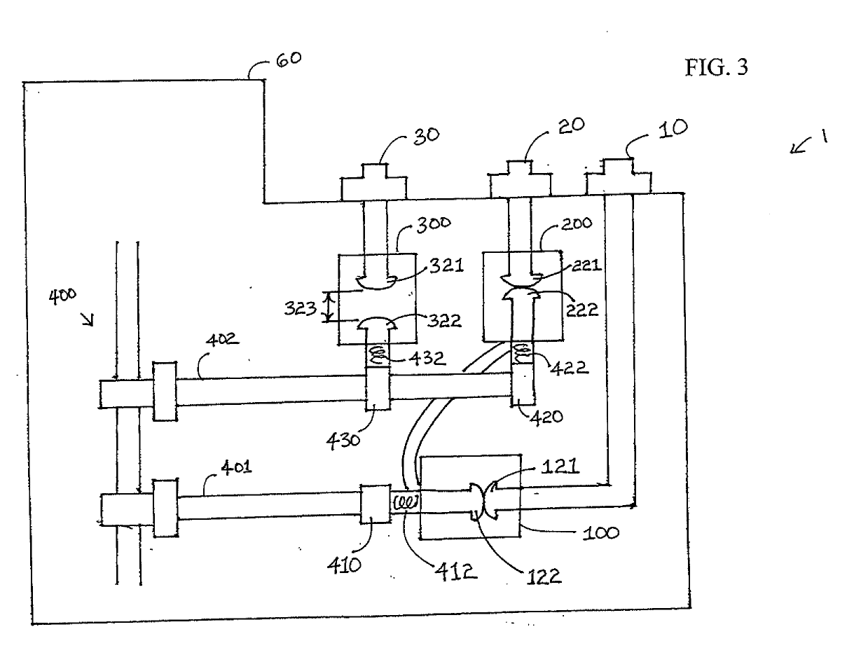

In accordance with an embodiment of switch 1, lever 501 can be placed in a CLOSED position (as seen in FIG. 3) wherein first vacuum bottle 100 and second vacuum bottle 200 are in the CLOSED condition, thus electrically connecting line bushing 10 and load bushing 20 while ground bottle 300 remains in the open condition. As shown, movable contact 122, 222 and fixed contact 121, 221 are physically in contact with each other within vacuum bottles 100, 200, thus permitting electricity to flow therebetween and thus between line bushing 10 to load bushing 20. Ground bottle 300 preferably remains in the OPEN condition.

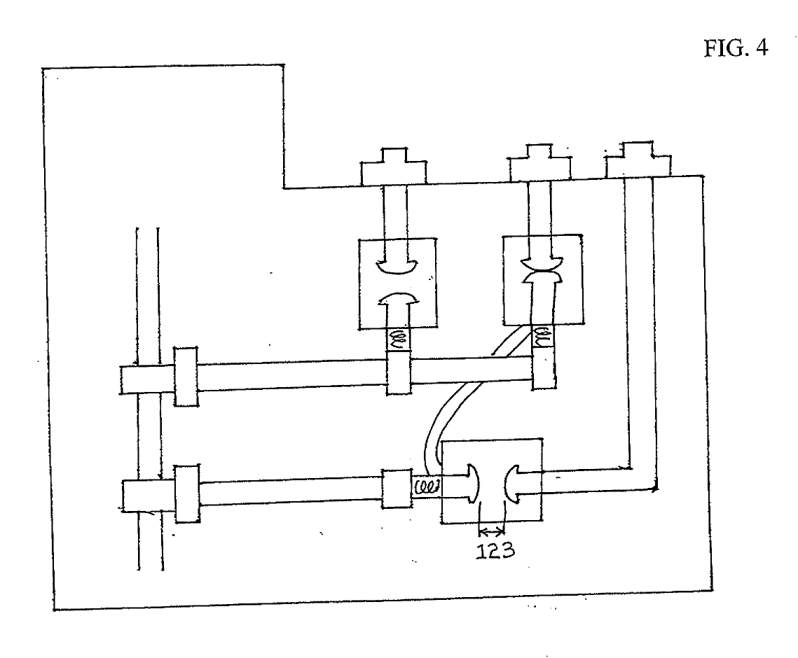

FIG. 4 illustrates an embodiment of switch 1 in a first OPEN position. In the embodiment shown, as lever 501 is moved to the first OPEN position, initially, first vacuum bottle 100 moves to an OPEN condition whereas second vacuum bottle 200 remains in a CLOSED condition. Ground bottle 300 preferably remains in an OPEN condition. As shown, a first gap 123 is present between first movable contact 122 and first fixed contact 121, thus electrically disconnecting first movable contact 122 from first fixed contact 121. Therefore, line bushing 10 and load bushing 20 are preferably electrically disconnected.

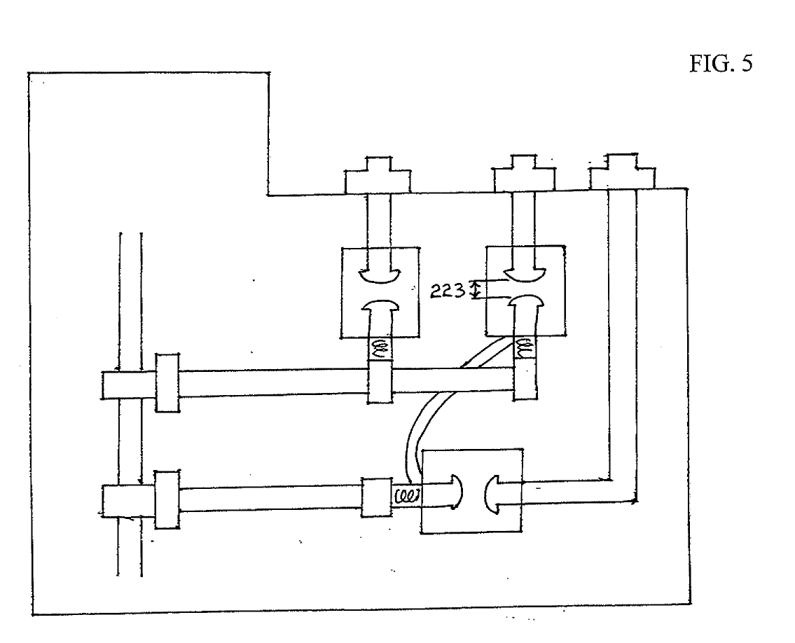

As lever 501 continues to a second OPEN position, as shown in FIG. 5, wherein the second vacuum bottle 200 is moved to an OPEN condition. Thus when lever 501 is in the second OPEN position, both first vacuum bottle 100 and second vacuum bottle 200 are in the OPEN condition. As shown, a second gap 223 can be present between second movable contact 222 and second fixed contact 221, thus electrically disconnecting second movable contact 222 from second fixed contact 221. In the embodiment shown, first vacuum bottle 100 remains in the OPEN position. Therefore, two air gaps 123, 223 can be present, thus providing two breaks in the circuit in switch 1. Accordingly, should there be a leak in first vacuum bottle 100, wherein first movable contact 122 is electrically connected to first fixed contact 121 notwithstanding the presence of first gap 123, switch 1 can remain electrically disconnected because second vacuum bottle 200 can remain in an OPEN condition and prevent electric flow. This substantially eliminates the risk of a lineman accidentally coming into contact with a live circuit because of a mistaken belief that the switch is open as indicated, which is a hazard posed by the prior art switches.

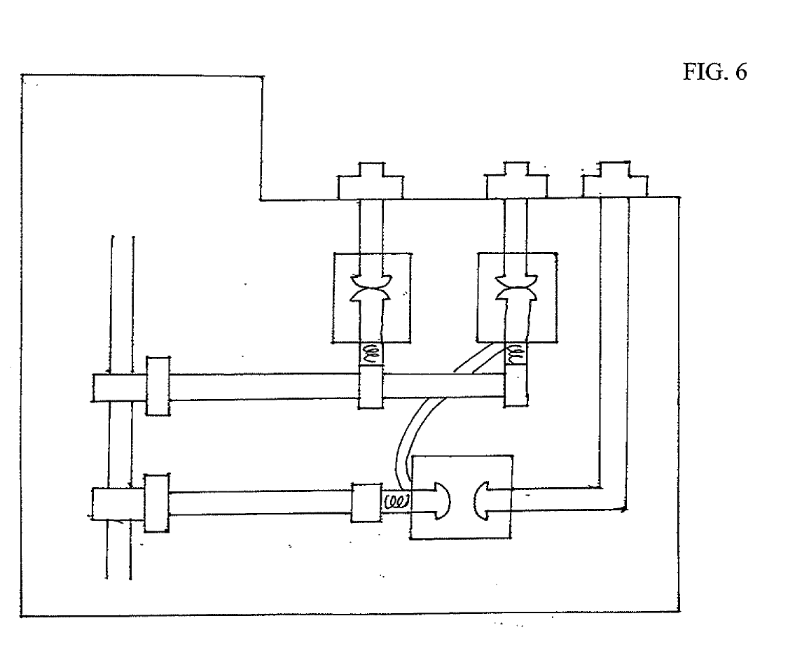

As shown in FIG. 6, an embodiment of switch 1 provides for an additional position, the GROUND position. As lever 501 is moved to the GROUND position, bottle 200 and bottle 300 can each move to a closed condition. Preferably, switch 1 is already in the second OPEN position when entering the GROUND position, and therefore first vacuum bottle 100 is already in an open condition thus preventing the grounding of the cable circuit connected to line bushing 10. As shown, vacuum bottles 200, 300 are in a closed position, thus electrically connecting the electric circuit connected to load bushing 20 and ground pad 30. Alternatively, second vacuum bottle 200 may remain in the OPEN position, by way of non-limiting example, by internal wiring between second bottle 200 and ground bottle 300 while providing the connection of load bushing 20 to ground pad 30.

In general terms, actuating assembly 400 preferably comprises a first shaft 401 connected to a first cam 410, which is preferably connected to first movable contact 122 of first vacuum bottle 100. A second shaft 402 can also be provided in actuating assembly 400, wherein second shaft 402 is connected to a second cam 420, which is preferably connected to second movable contact 222 of second vacuum bottle 200, and a third cam 430 connected to third movable contact 322 of ground bottle 300. Accordingly, as lever 501 is moved between the different positions, shafts 401, 402 can be displaced, thus selectively moving movable contacts 122, 222, 322 toward or away from fixed contacts 121, 221, 321. By way of non-limiting example, actuating assembly 400 can include a third shaft 403 connected to lever 501 and shafts 401, 402 such that as lever 501 pivots between the various positions (CLOSED, first OPEN, second OPEN, GROUND), third shaft 403 can rotate to selectively displace first shaft 401 and/or second shaft 402. First shaft 401 and second shaft 402 can engage third shaft 403 via a cam mechanism or any other suitable mechanism as a matter of application specific design choice. Preferably, actuating assembly 400 includes a plurality of springs 412, 422, 432 connected to movable contacts 122, 222, 322 to urge movable contacts 122, 222, 322 toward fixed contacts 121, 221, 321, respectively. Springs 412, 422, 432 can be extended and contracted by controlling the pressure applied thereon, such pressure being controlled by the respective shaft 410, 420.

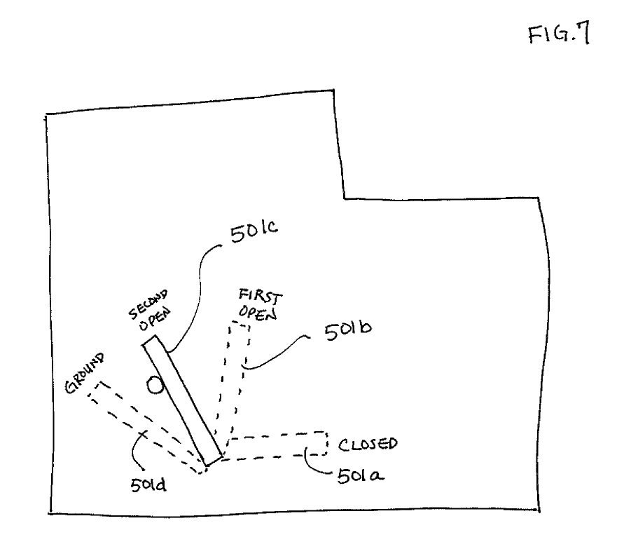

In accordance with an embodiment of switch 1 illustrated in FIG. 7, housing 600 can include a plurality of indicators, such as signs indicating the status of switch 1. For example, when lever 501 is positioned such that switch 1 is in the CLOSED position, represented by the dashed lines indicated generally as 501a, a sign indicating the same can be provided on housing proximate lever 501, as shown. A second sign indicating that switch 1 is in the first OPEN position can also be provided proximate the corresponding position of lever 501, represented by the dashed lines indicated generally as 501b. A third sign indicating that switch 1 is in the second OPEN position can also be provided proximate the corresponding position of lever 501 indicated generally as 501c. Therefore the lineman has an effective visible confirmation that switch 1 is indeed open, and that no electric current is flowing therewithin. A sign indicating ground, preferably a fourth sign, can also be provided on housing 600 proximate the corresponding position of lever 501, indicated in dashed lines at 501d, when switch 1 is in the GROUND position.

In accordance with an embodiment of switch 1, lever 501 can pivot between the various positions to open, close or ground switch 1. By way of non-limiting example, lever 501 can be horizontal when switch 1 is CLOSED, at an angle of about 120° when switch 1 is in the second OPEN position, and at an angle of about 140° when switch 1 is in the GROUND position. The signs can be provided on housing 600 accordingly.

Preferably, an additional indicator of GROUND position is provided. For example, lever 501 can be obstructed by a mechanical button 620 or other obstruction, which must be cleared before switch 1 can be grounded. In the embodiment shown, mechanical button 620 extends outward from housing 600 such that lever 501 cannot be moved past mechanical 620 unless mechanical button 620 is depressed. Therefore, the embodiment of switch 1 can ensure that the lineman is aware and intends to ground switch 1 and substantially prevents inadvertent grounding of switch 1.

Whereas the embodiments illustrated in FIGS. 1-7 comprises a manual lever 501 that actuates actuating assembly 400, for example, by causing shaft 440 to rotate, it is to be understood that alternate embodiments of the actuating assembly 400 can be used, as a matter of application specific design choice. For example, an automated system such as a computer-controlled motor may be used to change the status of the switch instead of a manual handle without departing from the spirit and the principles of the invention. Alternatively, a motorized bolt can be used, which is preferably controlled remotely, thus providing additional safety for the lineman. Multiple levers 501 can be used, for example, a lever for each vacuum bottle 100, 200, 300, or a first lever for first vacuum bottle 100 and a second lever for second vacuum bottle 200 and ground bottle 300, or any combination thereof, without deviating from the scope of the invention.

Switch 1 is preferably capable of operating to 15 kV of electricity, more preferably between 4 kV to 15 kV, most preferably either 4 kV or 15 kV.

While the present invention has been described with reference to one or more embodiments set forth in considerable detail for the purposes of making a complete disclosure of the invention, such embodiments are merely exemplary, and are not intended to limit or represent an exhaustive enumeration of all aspects of the invention. Further, it will be apparent to those of skill in the art that numerous changes, for example, the layout or positioning of the vacuum bottles, line, load, ground, shaft, cams, movable contacts, fixed contacts, the type of actuating assembly used, angles of operation between each of the positions, etc. may be made without departing from the spirit and the principles of the invention. The scope of the invention, therefore, shall be defined solely by the following claims.

I claim:

1. A vacuum switch comprising a first vacuum bottle and a second vacuum bottle electrically connected with each other:
the first vacuum bottle having a first fixed contact and a first movable contact, a first closed position wherein the first fixed contact is in physical contact with the first movable contact and electricity flows between the first fixed contact and the first movable contact, and a first open position wherein a first gap is provided between the first fixed contact and the first movable contact and electricity does not flow between the first fixed contact and the first movable contact; and
a second vacuum bottle having a second fixed contact and a second movable contact,
the second vacuum bottle having a second closed position wherein the second fixed contact is in physical contact with the second movable contact and electricity flows between the second fixed contact and the second movable contact,
the second vacuum bottle having a second open position wherein a second gap is provided between the second fixed contact and the second movable contact and electricity does not flow between the second fixed contact and the second movable contact;
wherein the switch has a first switch open position wherein the first vacuum bottle is in the first open position and the second vacuum bottle is in the second closed position, and a second switch open position wherein the first vacuum bottle is in the first open position and the second vacuum bottle is in the second open position.

2. The switch of claim 1, further comprising a ground vacuum bottle having a ground fixed contact and a ground movable contact constructed and arranged to be displaced toward and away from the ground fixed contact, the fixed ground contact being connected to a grounding element such that when the ground fixed, such that when the fixed ground contact is in physical contact with the movable ground contact, the switch is grounded.

3. The switch of clam 2, wherein the ground vacuum bottle is electrically connected to one of the first or second vacuum bottles.

4. The switch of claim 1, further comprising a visual indicator for indicating when the switch is in the first open position or the second open position.

5. The switch of claim 2, further comprising a visual indicator for indicating when the switch is grounded.

6. The switch of claim 1, further comprising a lever constructed and arranged to selectively displace the first movable contact and second movable contact.

7. The switch of claim 2, further comprising a lever constructed and arranged to selectively displace the first movable contact, the second movable contact and the ground movable contact.

8. The switch of claim 1, wherein the first vacuum bottle is electrically connected in series to the second vacuum bottle.

9. A vacuum switch comprising:
a housing having therein a first vacuum bottle and a second vacuum bottle electrically connected with each other;
the first and second vacuum bottles being constructed and arranged to be in an open position wherein electricity does not flow therethrough and a closed position wherein electricity can flow therethrough;

10. The switch of claim 9, wherein each of the first and second vacuum bottles includes a fixed contact and a movable contact, wherein a gap is present between the fixed contact and the movable contact when the vacuum bottle is in the open position.

11. The switch of claim 10, further comprising an actuating mechanism for selectively displacing the movable contact toward and away from the fixed contact.

12. The switch of claim 11, wherein the actuating mechanism includes a first actuator constructed and arranged to displace the movable contact of the first vacuum bottle, and a second actuator constructed and arranged to displace the movable contact of the second vacuum bottle.

13. The switch of claim 11, further comprising a pivotable lever constructed and arranged to displace one or more of the movable contacts.

14. The switch of claim 11, wherein the actuating mechanism includes a spring constructed and arranged to urge one of the movable contacts toward the corresponding fixed contact.

15. The switch of claim 9, further comprising one or more signs constructed and arranged to indicate whether one or more of the vacuum bottles is in the open position.

16. The switch of claim 13, wherein the lever includes a first position and a second position, the switch further comprising a first sign located proximate the first position and a second sign located proximate the second position, the first sign indicating a first state of the switch and the second sign indicating a second state of the switch.

17. The switch of claim 16, wherein both the first and second vacuum bottles are in the closed position when the switch is in the first state.

18. The switch of claim 16, wherein one of the first or second vacuum bottles is in the open position when the switch is in the second state.

19. The switch of claim 16, wherein both of the first and second vacuum bottles are in the open position when the switch is in the second state.

20. The switch of claim 13, wherein the lever is operatively connected to the first and second actuators, the lever constructed and arranged to activate the first actuator when pivoted by a first angle, the lever further being constructed and arranged to activate the second actuator when pivoted by a second angle.

21. The switch of claim 9, wherein the first vacuum bottle is electrically connected to the second vacuum bottle.

22. The switch of claim 9, wherein the first vacuum bottle is electrically connected to the second vacuum bottle in series.

23. The switch of claim 9, further comprising a ground vacuum bottle electrically connected to at least the second vacuum bottle, the ground vacuum bottle constructed and arranged to ground the switch when the vacuum bottle is in the closed position.

24. The switch of claim 23, further comprising a visual indicator that the switch is grounded.

25. The switch of claim 23, further comprising a verification mechanism constructed and arranged to prevent the ground vacuum bottles from being grounded inadvertently.

26. The switch of claim 25, wherein the ground vacuum bottle includes a movable contact and a fixed contact, the switch further comprising a lever constructed and arranged to displace the movable contact away from the fixed contact within the ground vacuum bottle when the lever moves in a ground direction, wherein the verification mechanism includes an obstruction device constructed and arranged to prevent the displacement of the lever in the ground direction.

27. A vacuum switch comprising:
a vacuum bottle having a movable contact selectively displaceable toward a fixed contact to a first position when the movable contact is in contact with the fixed contact to permit the flow of electricity between the movable contact and the fixed contact;
a ground bottle having a movable ground contact selectively displaceable toward a fixed ground contact to a ground position until the movable ground contact is in contact with the fixed ground contact to permit the flow of electricity between the movable ground contact and the fixed ground contact;
the vacuum bottle and the ground bottle being electrically connected, such that the switch is grounded when the vacuum bottle is in the first position and the ground bottle is in the ground position.
